(19) United States
(12) Patent Application Publication
(10) Pub. No.: US 2013/0056116 A1
(43) Pub. Date: Mar. 7, 2013

(54) COPPER ALLOY FOR ELECTRONIC DEVICE, METHOD OF PRODUCING COPPER ALLOY FOR ELECTRONIC DEVICE, AND COPPER ALLOY ROLLED MATERIAL FOR ELECTRONIC DEVICE

(71) Applicants: Yuki Ito, Okegawa-shi (JP); Kazunari Maki, Saitama-shi (JP)

(72) Inventors: Yuki Ito, Okegawa-shi (JP); Kazunari Maki, Saitama-shi (JP)

(73) Assignee: MITSUBISHI MATERIALS CORPORATION, Tokyo (JP)

(21) Appl. No.: 13/697,441

(22) PCT Filed: May 12, 2011
(86) PCT No.: PCT/JP2011/060962

§ 371 Date: Nov. 12, 2012

(30) Foreign Application Priority Data
May 14, 2010 (JP) 2010-112267

(51) Int. Cl. C22C 9/01; H01B 1/02; C22F 1/08

(52) U.S. Cl. 148/684; 148/436; 148/433; 148/434; 148/435

(57) ABSTRACT

A copper alloy for an electronic device containing Mg in a range of 2.6 atomic % or more and 9.8 atomic % or less, Al in a range of 0.1 atomic % or more and 20 atomic % or less, and the balance substantially consisting of Cu and unavoidable impurities.

### FIELD OF THE INVENTION

The present invention relates to a copper alloy for an electronic device, a method of producing a copper alloy for an electronic device, and a copper alloy rolled material for an electronic device that are applicable to electronic and/or electric components such as, for example, terminals, connectors, and relays.

Priority is claimed on Japanese Patent Application No. 2010-112267 filed on May 14, 2010, the content of which is incorporated herein by reference.

### BACKGROUND ART

Conventionally, in accordance with a reduction of the sizes of electronic devices and electric devices, there have been efforts to reduce the size and the thickness of electronic/electric components such as terminals, connectors, and relays used in these electronic devices and electric devices.

Therefore, a copper alloy having excellent springness, strength, and electrical conductivity is required as a material for constituting the electronic/electric device. Specifically, as described in Non Patent Reference 1, one having high yield strength and low Young's modulus is desirable as a copper alloy used in the form of electronic/electric device such as terminals, connectors, and relays.

For example, a Cu—Be alloy that contains Be is provided as a copper alloy having excellent springness, strength, and electrical conductivity in Patent Reference 1. This Cu—Be alloy is a precipitation-hardening type high strength alloy in which strength has been enhanced without deteriorating the electrical conductivity by aging-precipitation of CuBe in the matrix phase.

However, the raw material cost for the Cu—Be alloy is very high since the Be contained in the alloy is an expensive element. In addition, toxic Be oxide is generated during the production process of the Cu—Be alloy. Therefore, a production appliance must have a specific constitution and must be strictly controlled so as to prevent accidental leakage of Be oxide to the outer environment during the production process. As explained above, there has been problems that both of the raw material cost and production cost were very high for the Cu—Be alloy. In addition, from the view point of environmental measure, the alloy has been unwanted due to inclusion of a toxic Be element.

For example, Patent Reference 2 provides a Cu—Ni—Si based alloy (so called Corson alloy) as a material that can replace the Cu—Be alloy. The Corson alloy is a precipitation hardening type alloy that includes dispersed Ni₂Si precipitates and has a relatively high electrical conductivity, strength, and strain relaxation property. Therefore, the Corson alloy is frequently used in applications such as terminals for automobiles and small terminals for signal system, and is developed actively in the recent years.

Cu—Mg—P alloy described in Patent Reference 3 is developed as another alternative alloy.

### PRIOR ART REFERENCE

### Patent Reference

Patent Reference 1: Japanese Unexamined Patent Application, First Publication No. H04-268033.
Patent Reference 2: Japanese Unexamined Patent Application, First Publication No. H11-036055.
Patent Reference 3: Japanese Unexamined Patent Application, First Publication No. S62-227051.

### Non Patent Reference

Non Patent Reference 1: Koya NOMURA, “Technological Trends in High Performance Copper Alloy Strip for Connector and Kobe Steel's Development Strategy”, Kobe Steel engineering reports, Vol. 54, No. 1(2004), p. 2-8.

### SUMMARY OF THE INVENTION

### Problems to be Solved by the Invention

However, the Corson Alloy disclosed in Patent Reference 2 has a relatively high Young's modulus of 125 to 135 GPa. In the type of connectors having a constitution in which male tab is inserted to the female adapter while pushing up the spring contact section, a high Young's modulus is not preferred for the material for forming the connector since the contact pressure changes drastically at the time of insertion and easily exceeds the elasticity limit and may result in plastic deformation.

In the Cu—Mg—P alloy described in Patent Reference 3, the electrical conductivity was high, but mechanical properties such as yield strength and tensile strength were insufficient. In addition, there has been a problem in that the alloy was not applicable to connectors or the like due to a relatively high Young's modulus.

Based on a consideration of the above-described circumstance, an object of the present invention is to provide a copper alloy for an electronic device having a low Young's modulus, a high yield strength, and high electrical conductivity, and being appropriate for application in electric/electronic components such as terminals, connectors, and relays, and to provide a method of producing the copper alloy for an electronic device, and copper alloy rolled material for an electronic device.

### Solution of the Problems

In order to solve the above-described problems, a copper alloy for an electric device according to the present invention contains Mg in a range of 2.6 atomic % or more and 9.8 atomic % or less, Al in a range of 0.1 atomic % or more and 20 atomic % or less, and the balance substantially consisting of Cu and unavoidable impurities.

In the above-described constitution, the copper alloy for an electronic device is constituted as a copper alloy that contains Mg, Al, with the balance substantially consisting of Cu and unavoidable impurities, where the content of Mg and the content of Al are regulated as described-above. The copper alloy having this component composition has a low Young's modulus, a high strength, and relatively high electrical conductivity.

The above-described copper alloy for an electronic device may further contain at least one of Zn, Sn, Si, Mn, and Ni in an amount of 0.05% atomic % or more and 10 atomic % or less.

It is possible to improve the properties of copper alloy by adding the elements such as Zn, Sn, Si, Mn, and Ni to the above-described copper alloy for an electronic device. Therefore, it is possible to provide a copper alloy that is specifically appropriate for a specific application by making the alloy selectively include elements in accordance with intended use of the alloy.

The above-described copper alloy for an electronic device may further contain at least one of B, P, Zr, Fe, Co, Cr, and Ag in an amount of 0.01% atomic % or more and 1 atomic % or less.

It is possible to improve the properties of copper alloy by adding the elements such as B, P, Zr, Fe, Co, Cr, and Ag to the above-described copper alloy for an electronic device. Therefore, it is possible to provide a copper alloy that is specifically appropriate for a specific application by making the alloy selectively include elements in accordance with intended use of the alloy.

In the above-described copper alloy for an electronic device, yield strength at 0.2% (σ₀₂) may be 400 MPa or more.

In the above-described copper alloy for an electronic device, the Young's modulus E may be 125 GPa or less.

Where the copper alloy has yield strength σ_{0.2} at 0.2% of 400 MPa or more or Young's modulus E of 125 GPa or less, the alloy has high elastic energy coefficient (σ_{0.2}²/2 E) and is resistant to plastic deformation. Therefore, the alloy is specifically applicable for use in electronic/electric components such as terminals, connectors, and relays.

Average number of intermetallic compounds having a particle diameter of 0.1 μm or more in the above described copper alloy for an electronic device may be 10/μm² or less under the observation using a scanning electron microscope.

In this case, since precipitation of intermetallic compounds is suppressed such that the average number of intermetallic compounds having a particle diameter of 0.1 μm or more is controlled to be 10/μm² or less under the observation using a scanning electron microscope, precipitation of the intermetallic compounds is suppressed, and at least partial fractions of Mg and Al are dissolved (solid-solubilized) in the matrix phase (form solid solution with the matrix phase) of the alloy. By the thus dissolving at least partial fractions of Mg and Al in the matrix phase, it is possible to increase the strength and recrystallization temperature of the alloy while maintaining high electrical conductivity and to reduce the Young's modulus of the alloy.

The average number of inter metallic compounds having a particle diameter of 0.1 μm or more is calculated based on observation of an area of 4.8 μm² at 50000 fold magnification using a field emission type scanning electron microscope.

The particle diameter of each intermetallic compound (intermetallic compound particle) is achieved as an average value of the length of major axis (the length of the longest straight line that can be drawn in the particle without having contact with a grain boundary in the intermediate position) and the length of minor axis (the length of the longest straight line that can be drawn in the particle along the direction perpendicular to the major axis without having contact with a grain boundary in the intermediate position) of the intermetallic compound.

A method of producing a copper alloy for an electronic device according to the present invention is a method of producing a copper alloy for an electronic device to produce the above-described copper alloy for an electronic device, and the method includes: performing heating of a copper material composed of copper alloy containing Mg in a range of 2.6 atomic % or more and 9.8 atomic % or less, Al in a range of 0.1 atomic % or more and 20 atomic % or less, and the balance being substantially consisting of Cu and unavoidable impurities to a temperature of not lower than 600° C. and not higher than 800° C., performing quenching (rapid-cooling) to cool the heated copper material to 200° C. or lower with a cooling rate of 200° C./min or more; and performing working (processing) of the cooled copper material.

According to the above-described method of producing copper alloy for an electronic device, it is possible to dissolve (solid-solubilize) the Mg and Al by the heat treatment to heat the copper material containing Cu, Mg, and Al in the above-described composition to the temperature of not lower than 500° C. and not higher than 900° C. Here, if the heating temperature is lower than 500° C., there is a possibility that the dissolution is insufficient, and large amount of intermetallic compound remains in the matrix. On the other hand, if the heating temperature exceeds 900° C., there is a possibility that the copper material is partially molten to form liquid phase, resulting in inhomogeneous texture and surface state. Therefore, the heating temperature is controlled to be in a range of not lower than 500° C. and not higher than 900° C.

In addition, since the method includes quenching to cool the copper material to 200° C. or lower with a cooling rate of 200° C./min, it is possible to suppress precipitation of the intermetallic compounds during the cooling process, thereby dissolving at least partial fractions of Mg and Al in the matrix phase.

Further, since the method includes working to work the quenched copper material, it is possible to improve the strength of the alloy by work-hardening. The method of working is not particularly limited. For example, in accordance with the final shape of the alloy, rolling may be applied to make a plate or a bar, extrusion may be applied to make a wire or a rod, and forging pressing may be applied to make a bulk-shaped alloy. Working temperature is not particularly limited. In order to prevent an occurrence of precipitation, it is preferable to use a temperature in a range of −200 to 200° C. such that the working is performed in cold or warm working conditions. The working ratio (reduction ratio) is selected in accordance with the final shape of the alloy. Based on the consideration of work hardening, it is preferable to control the working ratio to be 20% or more, and preferably 30% or more.

So called low temperature annealing may be performed after the working. It is possible to further improve the mechanical properties of the alloy using low temperature annealing.

A copper alloy rolled material (rolled copper alloy) for an electronic device according to the present invention is made of the above-described copper alloy for an electronic device, and is made to have a Young's modulus E of 125 GPa or less and a yield strength σ6_{0.2} at 0.2% in the rolling direction of 400 MPa or more.

The copper alloy rolled material for an electronic device according to the above-described constitution has a high elastic energy coefficient (σ_{0.2}²/2 E), and does not easily cause plastic deformation.

The above-described copper alloy rolled material for an electronic device is preferably used as a copper raw material for constituting terminals, connectors, or relays.

### Effect of the Invention

According to the present invention, it is possible to provide a copper alloy for an electronic device that has a low Young's modulus, a high yield strength, and high electrical conductivity, and that is appropriately used in an electronic or electric device such as terminals, connectors, and relays, and to provide a method for producing a copper alloy for an electronic device, and a copper alloy rolled material for an electronic device.

### BRIEF EXPLANATION OF DRAWINGS

FIG. 1 is a flow diagram of a method of producing copper alloy for an electronic device according to an embodiment of the present invention.

FIG. 2 shows photographs taken by scanning electron microscopy in Example 12, where A shows a field at 10000 fold magnification, and B shows a field at 50000 fold magnification.

FIG. 3 shows photographs taken by scanning electron microscopy in Example 39, where A shows a field at 10000 fold magnification, and B shows a field at 50000 fold magnification.

### MODE FOR CARRYING OUT THE INVENTION

The following description provides explanation for copper alloy for an electronic device according to an embodiment of the present invention.

A copper alloy for an electronic device of the present invention has a composition containing Mg in a range of 2.6 atomic % or more and 9.8 atomic % or less, Al in a range of 0.1 atomic % or more and 20 atomic % or less, and further containing 0.05 atomic % or more and 10 atomic % or less of at least one or more selected from Zn, Sn, Si, Mn, and Ni, 0.01 atomic % or more and 1 atomic % or less of at least one or more selected from B, P, Zr, Fe, Co, Cr, and Ag, and the balance consisting of Cu and unavoidable impurities.

Under the observation of the copper alloy for an electronic device of the present embodiment using a scanning electron microscope, an average number of intermetallic compounds of particle diameter of 0.1 μm or more is 10/μm² or less.

### Mg

Mg is an element that has effects of improving the strength of the alloy and increasing the recrystallization temperature while avoiding a large reduction of electrical conductivity. In addition, it is possible to suppress the Young's modulus to a low value by dissolving Mg in the matrix phase.

Where the content of Mg is less than 2.6 atomic %, it is impossible to achieve its effects.

On the other hand, where the content of Mg exceeds 9.8 atomic %, a large amount of intermetallic compounds mainly composed of Cu and Mg remain when the alloy is heat treated for forming a solid-solution (solution treatment), possibly causing generation of cracks during the subsequent process such as working.

Based on the above-described reason, the content of Mg is controlled to be in a range of 2.6 atomic % or more and 9.8 atomic % or less.

In addition, since the Mg is an active element, if Mg is added in an excessive amount, there is a possibility that Mg oxide generated by the reaction with oxygen may be captured in the alloy during melting and casting of the alloy. In addition, as explained above, intermetallic compounds tend to remain in the time of performing solution treatment. Therefore, it is more preferable to control the amount of Mg to be in a range of 2.6 atomic % or more and 6.9 atomic % or less.

### Al

Al is an element that has an effect of largely improving the strength of the alloy while avoiding an increase of the Young's modulus by being dissolved in the copper alloy dissolving partial or total fraction of Mg.

Where the amount of Al is less than 0.1 atomic %, it is impossible to achieve the above effect. On the other hand, where the amount of Al exceeds 20 atomic %, a large amount of intermetallic compound remains in the time of performing heat treatment for forming a solid-solution, possibly causing cracks during the subsequent process such as working.

For the above-described reason, the amount of Al is controlled to be in a range of 0.1 atomic % or more and 20 atomic % or less.

### Zn, Sn, Si, Mn, Ni

The elements such as Zn, Sn, Si, Mn, Ni have effects of improving the properties of a copper alloy by being added to the copper alloy dissolving partial or total fractions of Mg and Al. Therefore, it is possible to improve the properties of the alloy by selective addition in accordance with the intended use. Specifically, Zn has an effect of improving the strength of the alloy without reducing the electrical conductivity.

Where the content of the elements such as Zn, Sn, Si, Mn, and Ni is less than 0.05 atomic %, it is impossible to achieve the effects of these elements. On the other hand, elements such as Zn, Sn, Si, Mn, and Ni are contained in the alloy in excess of 10 atomic %, electrical conductivity of the alloy is reduced largely. In addition, a large amount of intermetallic compound remains in the time of performing heat treatment for forming a solid-solution, possibly causing cracks or the like during the subsequent process such as working.

Based on the above-described reason, the amount of the elements such as Zn, Sn, Si, Mn, and Ni is controlled to be 0.05 atomic % or more and 10 atomic % or less.

### B, P, Zr, Fe, Co, Cr, Ag

Elements such as B, P, Zr, Fe, Co, Cr, and Ag have effects of improving properties of a copper alloy by being added to the copper alloy in which Mg and Al are partially or totally dissolved. Therefore, it is possible to improve the property of the alloy by selective addition in accordance with the intended use.

Where the content of the elements such as B, P, Zr, Fe, Co, Cr, and Ag is less than 0.01 atomic %, it is impossible to achieve their effects. On the other hand, where the elements such as B, P, Zr, Fe, Co, Cr, and Ag are contained in excess of 1 atomic %, the electrical conductivity is largely reduced. In addition, there is a possibility that large amount of compounds remains in the time of heat treatment for forming a solid-solution.

For the above-described reason, the amount of elements such as B, P, Zr, Fe, Co, Cr, and Ag is controlled to be 0.01 atomic % or more and 1 atomic % or less.

The unavoidable impurities may include Ca, Sr, Ba, rare earth element, Elf, V, Nb, Ta, Mo, W, Re, Ru, Os, Se, Te, Rh, Ir, Pd, Pt, Au, Cd, Ga, In, Li, Ge, As, Sb, Ti, Tl, Pb, Bi, S, O, C, Be, N, H, Hg or the like.

The rare earth element is one or more selected from Sc, Y, La, Ce, Pr, Nd, Pm, Eu, Gd, Tb, Dy, Ho, Er, Tm, Yb, and Lu. Preferably, the total amount of these unavoidable impurities is controlled to be 0.3 mass % or less.

### Microstructure (Texture)

The result of observation of copper alloy for an electronic device of the present embodiment using a scanning electron microscope shows that average numbers of intermetallic compounds having a particle diameter of 0.1 μm or more is 10/μm² or less. That is, the intermetallic compounds are not precipitated in large number, and at least partial fractions of Mg and Al are dissolved in the matrix phase.

Where the solution treatment is incomplete, or large sized intermetallic compounds exist in a large amount due to precipitation of the intermetallic compounds after the solution treatment, these intermetallic compounds may function as starting points of cracking resulting in generation of cracks during the working, and largely reduce bendability. In addition, a large amount of intermetallic compounds increases the Young's modulus of the alloy. Therefore, such a microstructure is not preferred.

The result of examination of the microstructure shows that satisfactory bendability and a low Young's modulus can be obtained where the numbers of intermetallic compounds having a particle diameter of 0.1 μm or more is 10/μm² or less in the alloy, that is, where the intermetallic compounds are absent or exist in a small amount.

In order to achieve the above described effect securely, it is preferable to control the numbers of intermetallic compound having a particle diameter of 0.1 μm or more is in the alloy controlled to be 1/μm² or less in the alloy. More preferably, the numbers of intermetallic compound having a particle diameter of 0.05 μm or more is controlled to be 1/μm² or less in the alloy.

The average number of the intermetallic compounds is calculated based on observation of an area of 4.8 μm² at 50000 times magnification using a field emission type scanning electron microscope.

The particle diameter of each intermetallic compound is achieved as an average value of the length of major axis (the length of the longest straight line that can be drawn in the particle without having contact with a grain boundary in the intermediate position) and the length of minor axis (the length of the longest straight line that can be drawn in the particle along the direction perpendicular to the major axis without having contact with a grain boundary in the intermediate position) of the intermetallic compound.

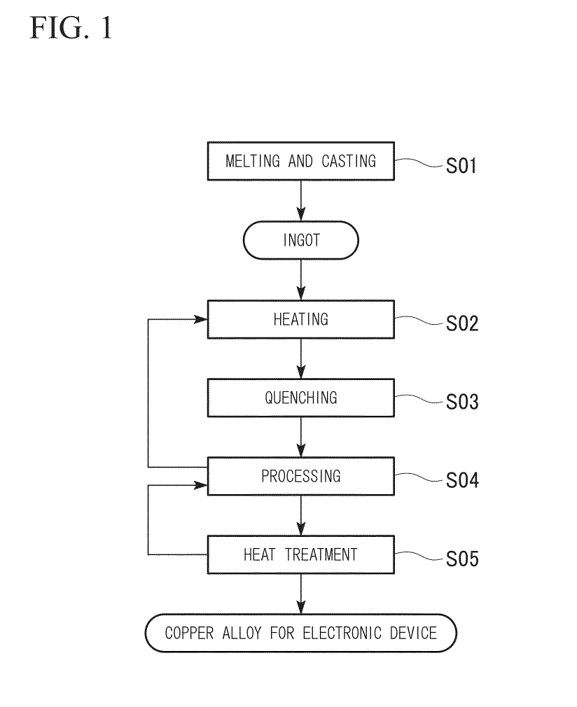

Next, a method of producing a copper alloy for an electronic device of the present embodiment having the above-described constitution is explained with reference to the flow diagram shown in FIG. 1.

### Melting and Casting Step: S01

Firstly, the above-described elements are added to a copper melt formed by melting of copper raw material, and the composition of the melt is controlled to form a melt of copper alloy. The elements such as Mg and Al may be added by using simple substances of Mg, Al, or the like, or by using precursor alloy. On the other hand, raw material (raw materials) including the above-described elements and the copper raw material may be molten simultaneously. The melt may also be formed by using recycled material or scraped material of the alloy of the present embodiment.

Preferably, the copper melt is a melt of so called 4NCu having a purity of 99.99% by mass or more. Preferably, the melting is performed by using a vacuum furnace or an atmospheric furnace while controlling the atmosphere to be inert gas atmosphere or reduced atmosphere so as to suppress oxidization of elements such as Mg and Al.

Next, an ingot is produced by pouring the copper alloy melt of controlled composition to a mold. Where the mass production effect is taken into consideration, it is preferable to use a continuous casting method or a semi-continuous casting method.

### Heating Step: 02

Next, a heating treatment is performed so as to homogenize and solid-solubilize the obtained ingot. The interior of the ingot includes intermetallic compounds that are generated by enrichment of the added elements as a result of segregation of these elements during the solidification process of the alloy. Therefore, so as to eliminate or reduce the segregation and intermetallic compounds, the ingot is subjected to the heating treatment to heat the ingot to not lower than 500° C. and not higher than 900° C., thereby diffusing the added elements homogeneously in the ingot and/or dissolving the added elements in the matrix phase. Preferably, the heating step S02 is performed under a non-oxidizing or reduced atmosphere.

### Quenching Step (Rapid Cooling Step): S03

Next, the ingot heated to not lower than 500° C. and not higher than 900° C. in the heating step 02 is cooled to the temperature of not higher than 200° C. with a cooling rate of 200° C./min. Precipitation of intermetallic compounds including Mg and Al dissolved in the matrix phase is suppressed by this quenching step S03, and an average number of intermetallic compounds having a particle diameter of 0.1 μm or more is controlled to be 10/μm² or less.

In order to make the rough processing efficient and to homogenize the microstructure, it is possible to use the constitution in which hot working is performed after the above-described heating step S02 and the above-described quenching step S03 is performed after the hot working. In this case, the working process is not particularly limited. For example, rolling may be applied where the final shape is a plate or a strip, and wire drawing, extrusion, groove rolling or the like may be applied where the final shape is a wire or a rod, and forging or pressing may be performed where the final shape is a bulk shape.

### Working Step: S04

The ingot after the heating step S02 and the quenching step S03 is cut where necessary, and is subjected to surface grinding where necessary in order to remove oxide film or the like generated during the heating step S02, quenching step S03 or the like. Then, the ingot is worked to the final shape.

The working process is not particularly limited. For example, rolling may be applied where the final shape is a plate or a strip, and wire drawing, extrusion, or groove rolling may be applied where the final shape is a wire or a rod, and forging or pressing may be performed where the final shape is a bulk shape.

Although the thermal conditions in the working step S04 is not particularly limited, it is preferable to control the temperature to be in a range of −200° C. to 200° C. such that the working is performed by cold working or warm working. The working ratio is selected discretionarily such that the shape of the alloy is made close to the final shape of the alloy. In order to improve the strength of the alloy by work hardening, it is preferable to control the working ratio to be 20% or more. In order to further enhance the strength, it is preferable to control the working ratio to be 30% or more.

The above-described heating step S02, the quenching step S03, and the working step S04 may be performed repeatedly. In this case, the second or following heating step S02 is performed with an intention of completing a solution treatment, recrystallizing the microstructure, or softening the alloy so as to improve the workability. The second or the following step is performed not on the ingot, but on the worked material.

### Heat Treatment Step: S05

Next, the worked material obtained by the working step S04 is subjected to heat treatment in order to perform low-temperature anneal hardening of the alloy or to remove residual strain. Conditions of the heat treatment step S05 is discretionarily determined in accordance with the properties that are desired in the produced product.

In the heat treatment step S05, it is necessary to control the heat treatment conditions (temperature, duration, cooling rate) such that intermetallic compounds of large size do not precipitate in large amount. For example, it is preferable to use heating for about 1 minute to 1 hour at 200° C., and for about 1 second to 1 minute at 300° C. Preferably, the cooling rate is controlled to be 200° C./min or more.

The method of the heat treatment is not particularly limited. It is preferable to perform heat treatment for 0.1 second to 24 hours at 100 to 500° C. under non-oxidizing or reducing atmosphere. The method of cooling is not particularly limited. It is preferable to use a method such as water-quenching such that the cooling rate is 200° C./min or more.

Further, the above-described working step S04 and the heat treatment step S05 may be performed repeatedly.

Thus, the copper alloy for an electronic device according to the present embodiment is produced. The copper alloy for an electronic device of the present embodiment is controlled to have a Young's modulus E of 125 GPa or less, and a yield strength σ_{0.2} at 0.2% of 400 MPa or more.

The copper alloy for an electronic device having the above-described constitution contains Mg in a range of 2.6 atomic % or more and 9.8 atomic % or less and Al in a range of 0.1 atomic % or more and 20 atomic % or less. The copper alloy of such a composition has a low Young's modulus, a high strength, and a relatively high electrical conductivity.

Specifically, the Young's modulus E is 125 GPa or less, the yield strength σ_{0.2} at 0.2% is 400 MPa or more. Therefore, the alloy has a high elastic energy coefficient (σ₂²/2 E) and is not plastically deformed easily. Therefore, the alloy is specifically applicable to electronic/electric components such as terminals, connectors, relays or the like.

In the present embodiment, the alloy further contains at least one or more selected from Zn, Sn, Si, Mn, and Ni in an amount of 0.05 atomic % or more and 10 atomic % or less, and contains at least one or more selected from B, P, Zr, Fe, Co, Cr, and Ag in an amount of 0.01 atomic % or more and 1 atomic % or less.

The elements such as Zn, Sn, Si, Mn, and Ni and the elements such as B, P, Zr, Fe, Co, Cr, and Ag have effects of improving properties of the copper alloy by being added to the copper alloy dissolving Mg and Al. Therefore, by adding these elements in accordance with the intended use, it is possible to provide a copper alloy of an electronic device that is specifically appropriate for the intended use.

In the copper alloy for an electronic device of the present embodiment, the average number of the intermetallic compounds having a particle diameter of 0.1 μm or more is 10/μm² or less under the observation using a scanning electron microscope.

Since the average number of intermetallic compounds having a particle diameter of 0.1 μm or more is controlled to be in the above-described range, precipitation of coarse intermetallic compound is suppressed and at least partial fractions of Mg and Al are dissolved in the matrix phase. Therefore, it is possible to increase the strength and recrystallization temperature while maintaining high electrical conductivity and to reduce the Young's modulus. In addition, satisfactory bendability can be achieved.

The method of producing copper alloy for an electronic device according to the present embodiment includes heating step S02 to heat the ingot or the worked material of the above-described composition to the temperature of not lower than 500° C. and not higher than 900° C. Therefore, Mg and Al can be dissolved by the heating step S02.

The method includes quenching step S03 to cool the ingot or the worked material that has been heated to not lower than 500° C. and not higher than 900° C. by the above-described heating step S02 to 200° C. or lower with a cooling rate of 200° C./min or more. Therefore, it is possible to suppress precipitation of a large sized intermetallic compounds in a large amount during the cooling process.

Further, since the method includes working step S04 to work the quenched material, it is possible to improve the strength of the alloy by work hardening.

Since the heat treatment step S05 is performed after the working step S04 so as to perform low temperature anneal hardening or to remove residual strain, it is possible to further improve the mechanical properties of the alloy.

As described above, according to the copper alloy for an electronic device of the present embodiment, it is possible to provide a copper alloy for an electronic device that has a low Young's modulus, a high yield strength, a high electrical conductivity, and excellent bendability, and that is appropriately applicable to electronic/electric components such as terminals, connectors, relays or the like.

While the copper alloy for an electronic device according to the present embodiment is explained above, the present invention is not limited to the above-described embodiment. Modification can be made discretionarily in the range without a technical scope of the invention.

For example, while an example of a method of producing copper alloy for an electronic device is explained in the above-described embodiment, the production method of the alloy is not limited to the present embodiment, and the alloy may be produced using a method selected from conventional production methods.

### EXAMPLE

In the following description, the results of affirmation experiments that were performed to affirm the effects of the present invention are explained.

A copper raw material composed of oxygen-free copper having a purity of 99.99% by mass or more (ASTM B152 C10100) is prepared. In each sample, the copper raw material was installed in a crucible made of high purity graphite, and was molten by high frequency melting in an atmospheric furnace under an Ar gas atmosphere. Various accessary elements were added to each of the thus obtained copper melts, and the melts were made to have compositions shown in Tables 1 and 2, and ingots were produced by pouring each melt to a carbon mold. The ingot was controlled to have a thickness of ca. 20 mm, a width of ca. 20 mm, and a length of ca. 100 to 120. The balance of each composition shown in Tables 1 and 2 is copper and unavoidable impurities.

The obtained ingots were subjected to heat treatment under Ar gas atmosphere for 4 hours under temperature conditions shown in Tables 1 and 2, and were subjected to water quenching.

After the heat treatment, each ingot was cut and was subjected to surface grinding for removing oxide film.

After that, cold rolling was performed under conditions shown in Tables 1 and 2, and strips having a thickness of ca. 0.5 mm and a width of ca. 20 mm were produced.

The obtained strips were subjected to heat treatment under conditions described in Tables 1 and 2, and strips for property evaluation were produced.

### Evaluation of Properties

The occurrence or absence of edge cracking during the cold rolling was observed in order to evaluate workability. The strips that did not show or scarcely showed edge cracking under visual observation were evaluated as “A (Excellent)”. The strips that showed occurrence of small edge cracking of less than 1 mm in length were evaluated as “B (Good)”. The strips that showed the occurrence of edge cracking of 1 mm or more and less than 3 mm in length were evaluated as “C (Fair)”. The strips that showed occurrence of large edge cracking of 3 mm or more in length were evaluated as “D(Bad)”. The strips that occurred fracture due to edge cracking during the rolling were evaluated as “E (Very Bad)”.

Here, the length of the edge cracking denotes the length of the edge cracking measured from the edge of the width of the rolled member towards the center of the width.

In addition, the mechanical properties and the electrical conductivity were measured using the strips for property evaluation.

### Mechanical Property

13B test pieces standardized in JIS Z 2201 were obtained from the strips for property evaluation and were subjected to measurement of yield strength σ_{0.2} at 0.2% by the off-set method in accordance with JIS Z 2241.

Strain gauge was attached to each of the above-described test pieces and load and elongation were measured. The Young's modulus was determined from inclination of stress-strain curve obtained from these data.

Each of the test pieces was obtained such that direction of tension during the tensile strength test was parallel to the rolling direction of the strips for property evaluation.

### Electrical Conductivity

Test specimens of 10 mm in width and 60 mm in length were obtained from strips for property evaluation, and electric resistance was measured using a four-terminal method. The volume of each specimen was calculated from measurement of the dimensions of the specimen using a micrometer. The electrical conductivity was calculated from the measured electric resistance and the volume. The test specimen was obtained such that the longitudinal direction of the specimen was in parallel to the rolling direction of the strip for property evaluation.

### Observation of Microstructure

Rolled surface of each specimen was subjected to mirror-polishing and ion-etching. In order to examine the precipitation state of intermetallic compounds, the surface was observed using a field emission type scanning electron microscope (FE-SEM) at a 10000 fold magnification (ca. 120 μm²/area).

Next, in order to examine the density (number/μm²) of the intermetallic compounds, the area at a 10000 fold magnification (ca. 120 μm²/area) was selected such that the area did not show biased precipitation of the intermetallic compounds. In this area, photographs of 10 continuous areas (ca. 4.8 μm²/area) were taken at a 50000 fold magnification. The particle diameter of each intermetallic compound was achieved as an average value of the length of major axis (the length of the longest straight line that can be drawn in the particle without having contact with a grain boundary in the intermediate position) and the length of a minor axis (the length of the longest straight line that can be drawn in the particle along the direction perpendicular to the major axis without having contact with a grain boundary in the intermediate position). Densities (number/μm²) of intermetallic compounds of 0.1 μm in particle diameter and 0.05 μm in particle diameter were determined.

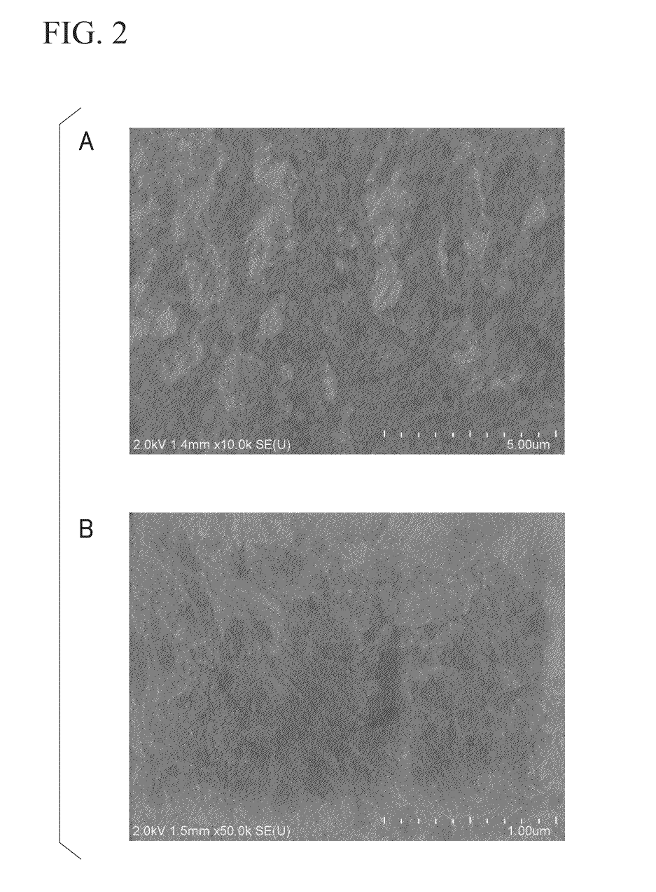

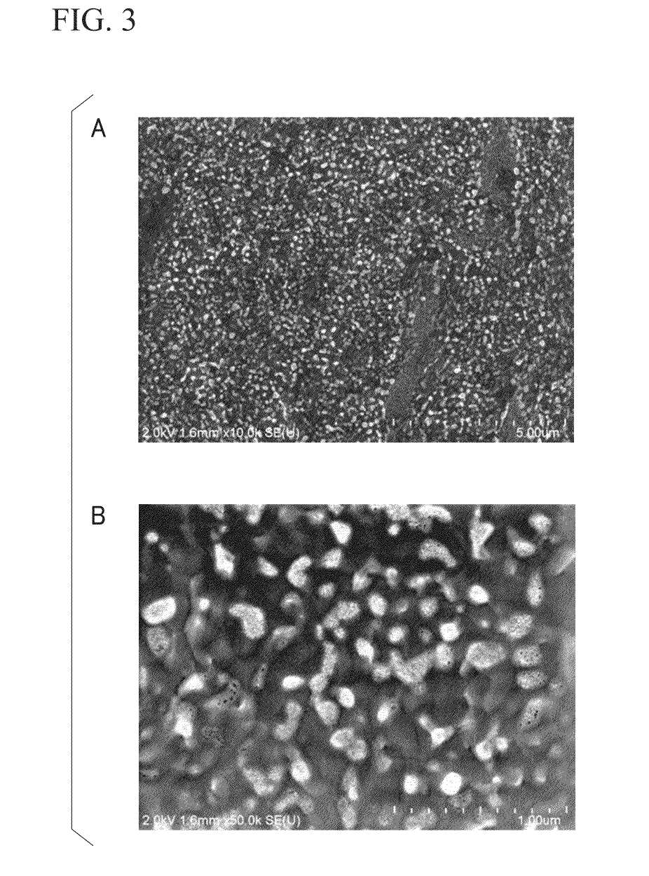

Conditions and results of evaluation are shown in Tables 1 and 2. As examples of the above-described observation of microstructures, SEM observation photographs of the Inventive Example 12 and Inventive Example 39 are shown in FIG. 2 and FIG. 3. In FIG. 2 and FIG. 3, A shows an area at 10000 fold magnification and B shows an area at 50000 fold magnification.

TABLE 1

| | | | | | | | | | | | | Microstructure | | | |
|---|---|---|---|---|---|---|---|---|---|---|---|---|---|---|---|
| | | | | | | | | Heat | | | Elec- | observation | | | |
| | | | | Additional | | Temper- | Working | treatment | | | trical | (number/μm²) | | Yield | Young |
| | | Mg | Al | element | | ature in | ratio in | conditions | | Edge | conduc- | 0.05 μm | 0.1 μm | strength | modu- |
| | | (at. | (at. | Ele- | (at. | heating | working | Temper- | Dura- | crack- | tivity | or | or | at 0.2% | lus |
| | | %) | %) | ment | %) | step | step | ature | tion | ing | (% IACS) | more | more | MPa | GPa |
| Examples | 1 | 3.1 | 1.0 | — | | 715° C. | 93% | 200° C. | 1 h | A | 35% | 0 | 0 | 697 | 117 |
| according | 2 | 3.3 | 4.5 | — | | 715° C. | 93% | 200° C. | 1 h | A | 21% | 0 | 0 | 810 | 116 |
| to the | 3 | 3.2 | 8.7 | — | | 715° C. | 93% | 200° C. | 1 h | B | 16% | 0 | 0 | 926 | 114 |
| present | 4 | 3.0 | 15.0 | — | | 715° C. | 93% | 200° C. | 1 h | C | 13% | 0 | 0 | 1150 | 113 |
| invention | 5 | 4.4 | 1.0 | — | | 715° C. | 93% | 200° C. | 1 h | B | 31% | 0 | 0 | 781 | 111 |
| | 6 | 4.5 | 2.0 | — | | 715° C. | 93% | 200° C. | 1 h | B | 26% | 0 | 0 | 806 | 111 |
| | 7 | 4.7 | 3.0 | — | | 715° C. | 93% | 200° C. | 1 h | B | 23% | 0 | 0 | 836 | 111 |
| | 8 | 4.5 | 4.0 | — | | 715° C. | 93% | 200° C. | 1 h | B | 20% | 0 | 0 | 895 | 110 |
| | 9 | 4.5 | 5.5 | — | | 715° C. | 93% | 200° C. | 1 h | B | 18% | 0 | 0 | 903 | 109 |
| | 10 | 4.4 | 6.7 | — | | 715° C. | 93% | 200° C. | 1 h | B | 17% | 0 | 0 | 948 | 108 |
| | 11 | 4.5 | 9.0 | — | | 715° C. | 93% | 200° C. | 1 h | B | 15% | 0 | 0 | 1009 | 106 |
| | 12 | 5.0 | 5.0 | — | | 715° C. | 93% | 200° C. | 1 h | B | 18% | 0 | 0 | 914 | 110 |
| | 13 | 6.2 | 0.5 | — | | 715° C. | 93% | 200° C. | 1 h | B | 29% | 0 | 0 | 812 | 107 |
| | 14 | 6.4 | 1.0 | — | | 715° C. | 93% | 200° C. | 1 h | A | 27% | 0 | 0 | 801 | 107 |
| | 15 | 6.5 | 2.0 | — | | 715° C. | 93% | 200° C. | 1 h | B | 23% | 0 | 0 | 849 | 105 |
| | 16 | 6.5 | 4.2 | — | | 715° C. | 93% | 200° C. | 1 h | C | 19% | 0 | 0 | 923 | 105 |
| | 17 | 7.0 | 1.0 | — | | 715° C. | 93% | 200° C. | 1 h | C | 25% | 0 | 0 | 850 | 105 |
| | 18 | 4.5 | 1.0 | Zn | 0.1 | 715° C. | 93% | 200° C. | 1 h | B | 31% | 0 | 0 | 788 | 110 |
| | 19 | 4.5 | 1.0 | Zn | 4.5 | 715° C. | 93% | 200° C. | 1 h | B | 22% | 0 | 0 | 846 | 108 |
| | 20 | 4.5 | 4.0 | Zn | 3.0 | 715° C. | 93% | 200° C. | 1 h | B | 18% | 0 | 0 | 936 | 107 |
| | 21 | 4.5 | 5.5 | Zn | 1.5 | 715° C. | 93% | 200° C. | 1 h | B | 17% | 0 | 0 | 910 | 109 |
| | 22 | 6.2 | 1.4 | Zn | 5.6 | 715° C. | 93% | 200° C. | 1 h | B | 21% | 0 | 0 | 903 | 104 |

TABLE 2

| | | | | | | | | | | | | Microstructure | | | |
|---|---|---|---|---|---|---|---|---|---|---|---|---|---|---|---|
| | | | | | | | | Heat | | | Elec- | observation | | | |
| | | | | Additional | | Temper- | Working | treatment | | | trical | (number/μm²) | | Yield | Young |
| | | Mg | Al | element | | ature in | ration in | conditions | | Edge | conduc- | 0.05 μm | 0.1 μm | strength | modu- |
| | | (at. | (at. | Ele- | (at. | heating | working | Temper- | Dura- | crack- | tivity | or | or | at 0.2% | lus |
| | | %) | %) | ment | %) | step | step | ature | tion | ing | (% IACS) | more | more | MPa | GPa |
| Examples | 23 | 4.5 | 1.0 | Sn | 0.1 | 715° C. | 93% | 200° C. | 1 h | B | 29% | 0 | 0 | 827 | 111 |
| according | 24 | 4.5 | 1.0 | Si | 0.1 | 715° C. | 93% | 200° C. | 1 h | B | 29% | 0 | 0 | 788 | 111 |
| to the | 25 | 4.5 | 1.0 | Mn | 0.1 | 715° C. | 93% | 200° C. | 1 h | B | 29% | 0 | 0 | 785 | 111 |
| present | 26 | 4.5 | 1.0 | Ni | 0.1 | 715° C. | 93% | 200° C. | 1 h | B | 30% | 0 | 0 | 788 | 111 |
| invention | 27 | 4.5 | 1.0 | B | 0.1 | 715° C. | 93% | 200° C. | 1 h | B | 30% | — | — | 816 | 112 |
| | 28 | 4.5 | 1.0 | P | 0.1 | 715° C. | 93% | 200° C. | 1 h | B | 28% | — | — | 792 | 112 |
| | 29 | 4.5 | 1.0 | Zr | 0.05 | 715° C. | 93% | 200° C. | 1 h | B | 28% | — | — | 811 | 111 |
| | 30 | 4.5 | 1.0 | Fe | 0.1 | 715° C. | 93% | 200° C. | 1 h | B | 26% | — | — | 793 | 111 |
| | 31 | 4.5 | 1.0 | Co | 0.1 | 715° C. | 93% | 200° C. | 1 h | B | 28% | — | — | 802 | 111 |
| | 32 | 4.5 | 1.0 | Cr | 0.1 | 715° C. | 93% | 200° C. | 1 h | B | 29% | — | — | 785 | 111 |
| | 33 | 4.5 | 1.0 | Ag | 0.1 | 715° C. | 93% | 200° C. | 1 h | B | 31% | — | — | 785 | 111 |

| | | | | | | | | | | | | | | |
|---|---|---|---|---|---|---|---|---|---|---|---|---|---|---|
| | 34 | 4.5 | 4.0 | — | 715° C. | 30% | 200° C. | 1 h | A | 21% | 0 | 0 | 532 | 112 |
| | 35 | 4.5 | 4.0 | — | 715° C. | 50% | 200° C. | 1 h | A | 21% | 0 | 0 | 659 | 112 |
| | 36 | 4.5 | 4.0 | — | 715° C. | 70% | 200° C. | 1 h | A | 21% | 0 | 0 | 794 | 110 |
| | 37 | 5.0 | 5.0 | — | 715° C. | 93% | 200° C. | 150 h | B | 18% | 0.4 | 0.0 | 911 | 112 |
| | 38 | 5.0 | 5.0 | — | 715° C. | 93% | 300° C. | 1 h | B | 19% | 7.2 | 0.8 | 856 | 117 |
| | 39 | 5.0 | 5.0 | — | 715° C. | 93% | 400° C. | 1 h | B | 21% | 18 | 13 | 758 | 120 |
| Compar- | 1 | 1.0 | — | — | 715° C. | 93% | 200° C. | 1 h | A | 73% | 0 | 0 | 522 | 127 |
| ative | 2 | 0.4 | 0.7 | — | 715° C. | 93% | 200° C. | 1 h | A | 60% | 0 | 0 | 520 | 126 |
| | 3 | 10.0 | 0.1 | — | 715° C. | 93% | — | — | E | — | — | — | — | — |
| | 4 | 5.0 | 21.0 | — | 715° C. | 93% | — | — | E | — | — | — | — | — |

| | | | | | | | | | | | | | | |
|---|---|---|---|---|---|---|---|---|---|---|---|---|---|---|
| Conventional | 1.8 | — | P | 0.01 | 715° C. | 93% | 200° C. | 1 h | A | 61% | — | — | 614 | 127 |

Comparative Examples 1, 2 having a smaller Mg content and a smaller Al content than the ranges of the present invention showed a high Young's modulus of 127 GPa and 126 GPa.

Comparative Example 3 having a larger Mg content than the range of the present invention and Comparative Example 4 having a larger Al content than the range of the present invention showed occurrence of large edge cracking in the time of cold rolling. As a result, it was impossible to examine their properties.

Conventional Example including 1.8 atomic % of Mg and 0.01 atomic % of P showed a high Young's modulus of 127 GPa.

On the other hand, the Young's modulus was controlled to be low value of 120 GPa or less showing excellent elasticity in each of Inventive Examples (Examples according to the present invention) 1-39.

Where Inventive Examples 8, 34, 35, and 36 having the same composition and different working ratio are compared, it was confirmed that the yield strength at 0.2% can be improved by increasing the working ratio.

Further, in Inventive Examples 18 to 22 added with Zn, improvement of yield strength at 0.2% was confirmed compared to Inventive Examples 5, 8, and 9 that contained Mg and Al in in the similar level but were not added with Zn.

With respect to the comparison of FIG. 2 and FIG. 3, energy dispersive X-ray analysis (EDS) did not detected intermetallic compounds in the microstructure of Inventive Example 12. On the other hand, occurrence of numerous large sized precipitates was observed in Inventive Example 39. While the Young's modulus E is controlled to be low in both of Inventive Example 12 and Inventive Example 39, comparison of the two samples showed that Inventive Example 39 including numerous intermetallic compounds had relatively higher Young's modulus E. From this observation, it was confirmed that suppression of intermetallic compounds was desired to further suppress the Young's modulus to be a low value.

As explained above, it was confirmed that the Examples according to the present invention could provide a copper alloy for an electronic device that had a low Young's modulus, a high yield strength, and high electrical conductivity, and that was appropriately applicable to electronic/electric devices such as terminals, connectors, relays or the like.

### INDUSTRIAL APPLICABILITY

According to the present invention it is possible to provide copper alloy for an electronic device that has low Young's modulus, high Yield strength, high electrical conductivity, and that is appropriately applicable to electronic/electric components such as terminals, connectors, and relays, and to provide a method of producing a copper alloy for an electronic device, and a copper alloy rolled material for an electronic device.

### EXPLANATION OF SYMBOLS

S02 Heating step
S03 Quenching step
S04 Heating step

1. A copper alloy for an electronic device containing Mg in a range of 2.6 atomic % or more and 9.8 atomic % or less, Al in a range of 0.1 atomic % or more and 20 atomic % or less, and the balance substantially consisting of Cu and unavoidable impurities.

2. The copper alloy for an electronic device according to claim 1, further containing at least one or more selected from Zn, Sn, Si, Mn, and Ni in an amount of 0.05 atomic % or more and 10 atomic % or less.

3. The copper alloy for an electronic device according to claim 1, further containing at least one or more selected from B, P, Zr, Fe, Co, Cr, and Ag in an amount of 0.01 atomic % or more and 1 atomic % or less.

4. The copper alloy for an electronic device according to claim 1, wherein a yield strength σ_{0.2} at 0.2% is 400 MPa or more.

5. The copper alloy for an electronic device according to claim 1, wherein a Young's modulus E is 125 GPa or less.

6. The copper alloy for an electronic device according to claim 1, wherein average number of intermetallic compounds having a particle diameter of 0.1 μm or more is 10/μm² or less.

7. A method of producing copper alloy for an electronic device that produced the copper alloy for an electronic device according to claim 1, the method comprising:
performing heating of copper material composed of copper alloy containing Mg in a range of 2.6 atomic % or more and 9.8 atomic % or less, Al in a range of 0.01 atomic % or more and 20 atomic % or less, and the balance being substantially consisting of Cu and unavoidable impurities to a temperature not lower than 500° C. and not higher than 900° C.;
performing quenching of the heated copper material to 200° C. or lower with a cooling rate of 200° C./min or more; and
performing working of the quenched copper material.

8. A copper alloy rolled material for an electronic device that comprises the copper alloy for an electronic device and that has a Young's modulus E of 125 GPa or less in the rolling direction, and a yield strength σ_{0.2} at 0.2% of 400 MPa or more.

9. A copper alloy rolled material for electronic device according to claim 8 that is used as a copper material to constitute terminals, connectors, and relays.

10. An electronic/electric component that comprises the copper alloy for an electronic device according to claim 1.

11. An electronic/electric component that comprises the copper alloy rolled material for an electronic device according to claim 8.

12. A terminal that comprises the copper alloy for an electronic device according to claim 1.

13. A terminal that comprises the copper alloy for an electronic device according to claim 8.

14. A connector that comprises the copper alloy for an electronic device according to claim 1.

15. A connector that comprises the copper alloy for an electronic device according to claim 8.
